(19) United States
(12) Patent Application Publication
(10) Pub. No.: US 2009/0075704 A1
(43) Pub. Date: Mar. 19, 2009

(54) Mobile communication device with charging module

(76) Inventor: Kevin Peichih Wang, Alhambra, CA (US)

Correspondence Address: DAVID AND RAYMOND PATENT FIRM, 108 N. YNEZ AVE., SUITE 128, MONTEREY PARK, CA, 91754, US

(21) Appl. No.: 11/901,790

(22) Filed: Sep. 18, 2007

(51) Int. Cl. H02J 7/00; H04B 1/38

(52) U.S. Cl. 455/573; 320/108

(57) ABSTRACT

A mobile communication device includes a battery controller and an inductive charger. The battery control is adapted for electrically connecting to a rechargeable battery of the portable electronic device. The inductive charger includes a power connector adapted for electrically connecting with a power source, and a transmitting inductor electrically coupling with the power connector for generating an electromagnetic induction, wherein the receiving inductor is electrically inducted to the transmitting inductor in a contact free manner for wirelessly transmitting an inductive charging power to the rechargeable battery of the portable electronic device through the transmitting inductor. Therefore, when the rechargeable battery of the portable electronic device is located within an induction distance of the inductive charger, the rechargeable battery of the portable electronic device is automatically charged.

### BACKGROUND OF THE PRESENT INVENTION

1. Field of Invention

This present invention relates to the field of battery charging and more particularly to the device and method of mobile devices battery charging by a contact free manner.

2. Description of Related Arts

As the fast developing technology in electronics and semiconductors, electronics devices are getting smaller and smaller. Portable and wireless are the obvious trend during the development of almost every electronic product. Especially in fields such as communication and personal organization, equipments must adapt the modern highly dynamic life style. The requirement of being smaller, faster, and more convenient can never be stopped.

But there is a bottleneck during this development. Power supply always limits the design and application of these kinds of products. Generally most portable devices, such as mobile phone, Personal Digital assistant (PDA), MP3 player, and laptop computer are using rechargeable batteries for power supply.

Rechargeable batteries are batteries that can be restored to full charge by the application of electrical energy. The energy is stored in the electrochemical cells. They come in many different designs using different chemicals. For example, Lithium-ion battery, one the most popular rechargeable battery, is using Lithium cobalt oxide (LiCoO₂) as the positive electrode. The negative electrode is made of carbon. They are separated by a separator, and are submerged in an organic solvent act as the electrolyte. When the battery charges, ions of lithium move through the electrolyte from the positive electrode to the negative electrode and attach to the carbon. During discharge, the lithium ions move back to the LiCoO₂ from the carbon.

The energy used to recharge rechargeable batteries mostly comes from mains electricity using an adapter unit. In current used rechargeable devices, especially communication devices, such kind of rechargeable battery is installed within the device. For charging, batteries can be removed and charged by designated charger, or most possibly, batteries are remained in the devices and are charged by the device.

There are several disadvantages for current charging manners. First, so many wires are used. When charging a battery within a mobile phone, one end of the charger will be connected with the communication device such as mobile phone, PDA, or the like, and locked. The other end of the charger will be plugged into the wall outlet. During the time of charging, the mobile phone is bonded with the charger which is very inconvenient, and people are quite easy to be tripped. Since the mobile phone and the charge are locked, a careless strain will cause the broken of a valuable mobile phone.

For conventional charging, the rechargeable batteries have two exposed metal electrodes which need to contact with the output pins of the charger to accept the charging current. These exposed electrodes will be oxidized in the air. When touched by people, they are covered with the cream from people's skin. All these will increase the resistance of charging. As a result, more energy will be consumed, and more heat will be generated which will largely shorten the lifetime of the rechargeable battery. For charging within the mobile phone, frequent plugging and unplugging the connector of the charger will worn out the contact components and cause a lot of inconvenience.

There is another problem. Battery chargers for mobile communication devices and other devices are notable in that they come in a wide variety of connector-styles and voltages, most of which are not compatible with other manufacturers' communication devices or even different models of communication devices from a single manufacturer. So it is often seen many chargers are massed together with their cables, and each of them has occupied a wall outlet. And if one adapter is broken or lost, exactly a same one has to be purchased. This causes a big waste.

It is necessary to develop a new method of charging which can overcome these disadvantages.

### SUMMARY OF THE PRESENT INVENTION

A main object of the present invention is to provide a charging module for rechargeable batteries of a mobile communication device using contact free manner.

Another object of the present invention is to provide a rechargeable battery arrangement for portable electronic devices including mobile communication device which is charged by contact free manner.

Another object of the present invention is to provide a mobile communicate device which comprises a rechargeable battery and is charged by contact free manner.

Another object of the present invention is to provide a method of charging rechargeable battery without having the battery contact with the charger directly.

In order to accomplish the above objects, the present invention provides a charging module for a portable electronic device having a rechargeable battery, comprising:

a battery controller comprising a battery connector adapted for electrically connecting to the rechargeable battery of the portable electronic device, and a receiving inductor electrically coupling with the battery connector; and

an inductive charger comprising a power connector adapted for electrically connecting with a power source, and a transmitting inductor electrically coupling with the power connector for generating an electromagnetic induction, wherein the receiving inductor is electrically inducted to the transmitting inductor in a contact free manner for wirelessly transmitting an inductive charging power to the rechargeable battery of the portable electronic device through the transmitting inductor in such a manner that when the rechargeable battery of the portable electronic device is located within an induction distance of the inductive charger, the rechargeable battery of the portable electronic device is automatically charged.

In order to accomplish the above objects, the present invention provides a rechargeable battery arrangement for a portable electronic device, comprising:

a rechargeable battery, which is adapted for electrically coupling with the portable electronic device, comprising an energy storage module and a battery controller, wherein the battery controller comprises a battery connector electrically connecting to the energy storage module and a receiving inductor electrically coupling with the battery connector; and

an inductive charger comprising a power connector adapted for electrically connecting with a power source, and a transmitting inductor electrically coupling with the power connector for generating an electromagnetic induction, wherein the receiving inductor is electrically inducted to the transmitting inductor in a contact free manner for wirelessly transmitting an inductive charging power to the energy storage module through the transmitting inductor in such a manner that when the rechargeable battery is located within an induction distance of the inductive charger, the energy storage module of the rechargeable battery is automatically charged.

In order to accomplish the above objects, the present invention provides a mobile communication device, comprising:

a charging module, comprising:

a battery controller, which is built-in with the communication module, comprising a battery connector electrically connecting to the rechargeable battery when the rechargeable battery is disposed in the battery compartment, and a receiving inductor electrically coupling with the battery connector; and

an inductive charger comprising a power connector adapted for electrically connecting with a power source, and a transmitting inductor electrically coupling with the power connector for generating an electromagnetic induction, wherein the receiving inductor is electrically inducted to the transmitting inductor in a contact free manner for wirelessly transmitting an inductive charging power to the energy storage module through the transmitting inductor in such a manner that when the rechargeable battery is located within an induction distance of the inductive charger, the energy storage module of the rechargeable battery is automatically charged.

In order to accomplish the above objects, the present invention provides a charging method for charging a replaceable battery by a recharging module which comprises a battery controller and an inductive charger, comprising the steps of:

(a) electrically coupling a receiving inductor of the battery controller with the replaceable battery;

(b) electrically coupling a transmitting inductor of the inductive charger with a power source;

(c) placing the battery controller within an induction distance of the inductive charger to electrically induct the transmitting inductor to the receiving inductor in a contact free manner; and

(d) wirelessly transmitting an inductive charging power from the inductive charger to the battery controller to electrically charge the rechargeable battery.

These and other objectives, features, and advantages of the present invention will become apparent from the following detailed description, the accompanying drawings, and the appended claims.

### BRIEF DESCRIPTION OF THE DRAWINGS

FIG. 1 is a block diagram of a charging module according to a first preferred embodiment of the present invention, illustrating the charging module being an external device for coupling with a portable electronic device.

FIG. 2 is a block diagram of a charging module according to a first preferred embodiment of the present invention, illustrating the charging module built-in with the rechargeable battery for coupling with the portable electronic device.

FIG. 3 is a block diagram of a charging module according to a first preferred embodiment of the present invention, illustrating the charging module being an internal device built-in with the portable electronic device.

FIG. 4 is a flow diagram of the present invention illustrating the method of contact free charging.

FIG. 5 is a perspective view of charging module according to the first to third embodiments of the present invention, illustrating the charging module being used as a home charger.

FIG. 6 is a perspective view of charging module according to the first to third embodiments of the present invention, illustrating the charging module being used as a vehicle charger.

### DETAILED DESCRIPTION OF THE PREFERRED EMBODIMENT

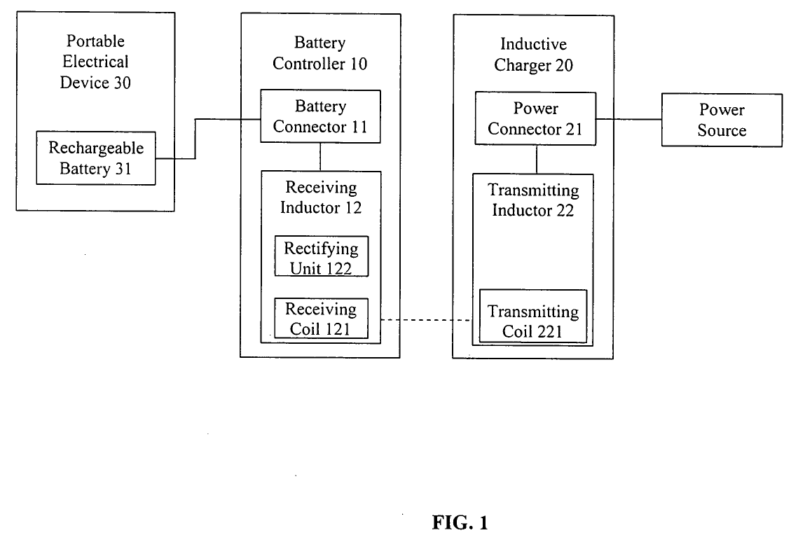

Referring to FIG. 1, a charging module according to a preferred embodiment of the present invention is illustrated, wherein the charging module is used for charging a rechargeable battery of a portable electronic device 30 including a mobile communication device such as mobile phone, PDA, wireless hand-free device.

The charging module comprises a battery controller 10, and an inductive charger 20. The battery controller 10 comprises a battery connector 11 which is electrically coupled with the portable electronic device 30. The portable electronic device 30 is a regular electronic device comprising a rechargeable battery 31 which supplies power to the portable electronic device 30, and can be charged through the portable electronic device 30.

The battery controller 10 also comprises a receiving inductor 12 which is electrically connected with the battery connector 11. In a preferred embodiment, the charging module is an external device for electrically connecting between the portable electronic device 30 and the power source.

Accordingly, the receiving inductor 12 and the battery connector 11 are connected though a cable 13. The receiving inductor 12 comprises a receiving coil 121 which is made of conductive material. In a preferred embodiment, the receiving coil 121 is fabricated in thin metal film. The thin metal film has a relatively small dimension. It occupies minimal volume and can be integrated into a tight space.

The receiving coil 121 is electrically connected with a rectifying unit 122 which rectifies the current generated by the receiving coil 121. This will protect the rechargeable battery 31 from being damaged by irregular current. For example, a current with opposite direction will be converted. The rectifying unit 122 is electrically connected with the battery connector 11. A close circuit is made when the battery connector 11 is electrically coupled with the portable electronic device 30 which has a rechargeable battery 31 installed. The charging current can flow into the battery. In a preferred embodiment of the present invention, the coil is sealed in a frame 123.

The inductive charger 20 transforms the energy from the power source into electromagnetic energy. The inductive charger 20 comprises a power connector 21 adapted for electrically connecting with a power source, and a transmitting inductor 22 electrically coupling with the power connector 21 for generating an electromagnetic induction. The transmitting inductor 22 comprises a transmitting coil 221 which converts electricity energy into electromagnetic energy.

The contact free charging is based on the Faraday's law of induction which states that the induced electromotive force in a closed loop equals the negative of the time rate of change of magnetic flux through the loop. In the present invention, the current passes trough the transmitting coil 221 of the transmitting inductor 22 and generates a magnetic flux. When the receiving coil 121 is placed next to the transmitting coil 221 within an induction distance, a current will be induced by the flux in the receiving coil 121. This current then flows to the rechargeable battery 31 for charging. Since the energy transmission is through magnetic flux, there is no current flow between the transmitting inductor 22 and the receiving inductor 12. As a result, no conductive contact is needed directly between the power source and the portable electronic device 30. If only the transmitting inductor 22 and the receiving inductor 12 are within the induction distance, energy transmission can be performed, charging can be achieved.

The power connector 21 of the inductive charger 20 can be adapted to different types of power sources. In the first embodiment of the present invention, the power source is a wall outlet with an AC voltage output of 100-240 V for using at places such as home or office. In this embodiment, the power connector 21 also comprises a voltage modulation unit 24 to modulate the input voltage from the wall outlet into a predetermined working voltage of the inductive charger 20. In the second embodiment of the present invention, the power source is a vehicle electric outlet with a DC voltage output of 12V which can be use in a vehicle.

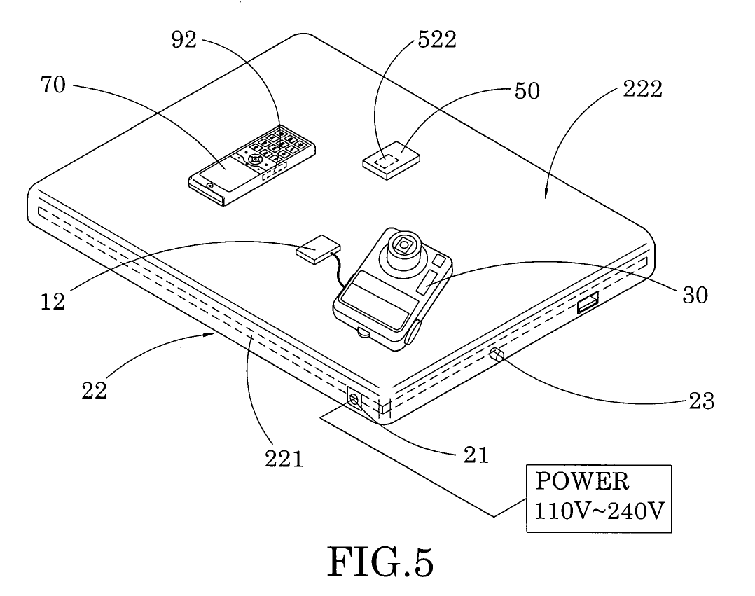

In the first embodiment, the charging module is used as a home charger. The inductive charger 20 also comprises a charging base 23. Referring FIG. 5, the charging base 23 comprises a receiving cavity 231 which receives the transmitting inductor 22, and a top platform 222 which is positioned above the transmitting inductor 22. The distance between the top platform 222 and the transmitting inductor 22 is within the induction distance. In this embodiment of the present invention, the receiving inductor 12 of the battery controller 10 can be positioned over the top platform 222 of the inductive charger 20. Therefore the receiving inductor 12 is located within the induction distance and can be induced to generate charging current. Also there is no need of physical contact and conductive connection between the battery controller 10 and the inductive charger 20. In other words, the user is able to simply dispose the portable electronic device 30, such as the mobile phone, on the top platform 222, the portable electronic device 30 will be automatically charged in wire-free manner.

In this embodiment of the invention, the area of the top platform 222 is larger than the area of the receiving inductor 12. Therefore multiple receiving inductors 12 can be placed over the top platform 222, which means more than one portable electronic devices 30 can be charged using a same inductive charger at the same time. Also, the multiple portable electronic devices 30 can be different types. It is worth to mention that the charging base 23 is relatively thin with respect to the top platform 22 to minimize the overall size of the inductive charger 20.

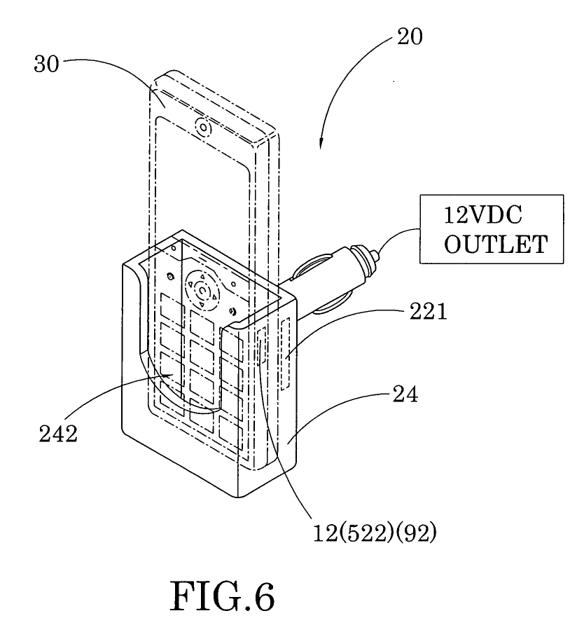

In another embodiment of the present invention, the charging module is used as a vehicle charger. The inductive charge 20 is electrically connected with the vehicle outlet, as shown in FIG. 6. The inductive charge 20 comprises a device holder 24. The device holder 24 comprises a receiving cavity 241 which receives the transmitting inductor 22, and a holding cavity 242 which holds the receiving inductor 12 of the battery controller 10. The holding cavity 242 holds the receiving inductor 12 in such a manner that the distance between the receiving inductor 12 and the transmitting inductor 22 is within the induction distance, so that inductive charging energy can be wirelessly transmitted form the inductive charger 20 to the battery controller 10 to realize contact free charging. In other words, the user is able to simply dispose the portable electronic device 30, such as the mobile phone, at the receiving cavity 241 of the device holder, the portable electronic device 30 will be automatically charged in wire-free manner.

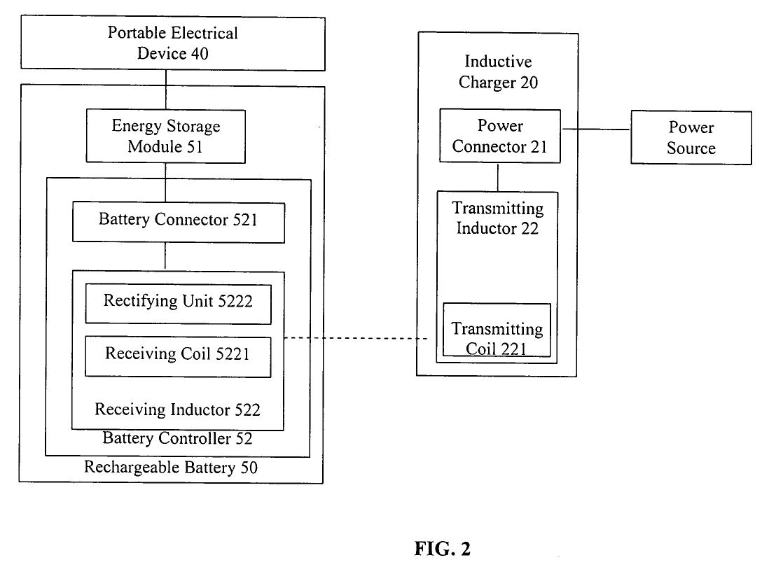

Referring to FIG. 2, the charging module of the present invention can be built-in with the rechargeable battery to form a rechargeable battery arrangement for a portable electronic device 40. The rechargeable battery arrangement comprises a rechargeable battery 50 and an inductive charger 60. The rechargeable battery 50 is adapted for electrically coupling with the portable electronic device 40 to: supply power. The rechargeable battery 50 comprises an energy storage module 51 which can store electric energy by charging, and supply energy to the electronic device by discharging. The rechargeable battery 50 also comprises a battery controller 52. The battery controller 52 is electrically connected with the energy storage module 51 and is controlling the charging of it.

The battery controller 52 further comprises a battery connector 521 which is electrically connected with the energy storage module 51; and a receiving inductor 522 which is electrically connected with the battery connector 521. The receiving inductor 522 comprises a receiving coil 5221 which is made of conductive material. In a preferred embodiment, the receiving coil 5221 is fabricated in thin metal film. The thin metal film has a relatively small dimension. It occupies minimal volume and can be integrated into a tight space.

The receiving coil 5221 is electrically connected with a rectifying unit 5222 which rectifies the current generated by the receiving coil 5221. This will protect the rechargeable battery from being damaged by irregular current. The rectifying unit 5222 is electrically connected with the battery connector 521. So a close charging loop is made. The charging current can flow into the battery.

In a preferred embodiment of the present invention, the whole rechargeable battery 50 is enclosed in a frame 53. The frame 53 comprises two electrodes 531 which are conductive with the two electrodes of the energy storage module 51. When the rechargeable battery 50 is installed in the portable electric device 40, the energy storage module 51 is electrically connected with the portable electric device 40 through these two electrodes 531 to supply energy. The frame 53 also comprises an induction face 532 where the receiving coil 5221 is located underneath.

The rechargeable battery arrangement also comprises an inductive charger 20 which transforms the energy from a power source into electromagnetic energy. The inductive charger 20 comprises a power connector 21 adapted for electrically connecting with a power source, and a transmitting inductor 22 electrically coupling with the power connector 21 for generating an electromagnetic induction. The transmitting inductor 22 comprises a transmitting coil 221 which converts electricity energy into electromagnetic energy. In the present invention, the current passes trough the transmitting coil 221 of the transmitting inductor 22 and generates a magnetic flux. When the receiving coil 5221 is placed next to the transmitting coil 221 within an induction distance, a current will be induced by the flux in the receiving coil 5221. This current then flows through the rectifying unite 5222, the battery connector 521, and the energy storage module 51 for charging.

Since the energy transmission is through magnetic flux, there is no current flow between the transmitting inductor 22 and the receiving inductor 522. As a result, no conductive contact is need. If only the transmitting inductor 22 and the receiving inductor 522 are within the induction distance, energy transmission can be performed, charging can be achieved.

The inductive charger 20 is the same as mentioned above. The inductive charger 20 also comprises a charging base 23. The charging base 23 comprises a receiving cavity 231 which receives the transmitting inductor 22, and a top platform 222 which is positioned above the transmitting inductor 22. The distance between the top platform 222 and the transmitting inductor 22 is within the induction distance. In this embodiment of the present invention, the rechargeable battery 50 can be positioned over the top platform 222 of the inductive charger 20 with the receiving inductor 522 locating within the induction distance and can be induced to generate charging current. Also there is no need of physical contact and conductive connection between the rechargeable battery 50 and the inductive charger 20.

In this embodiment of the invention, the area of the top platform 222 is larger than the area of the induction face 532 of the rechargeable battery 50. Therefore multiple rechargeable batteries 50 can be placed over the top platform 222, and can be charged using a same inductive charger 20 at the same time. Therefore, the user is able to replace the original battery of the portable electronic device 40 by the rechargeable battery arrangement of the present invention such that the portable electronic device 40 can be automatically charged in a wire-free manner when the portable electronic device 40 is rested on the top platform 222.

The rechargeable battery 50 can also be charged when it is installed within the portable electronic device 40. Place a portable electronic device 40 which has a rechargeable battery 50 of the rechargeable battery arrangement of the present invention over the top platform 222 of the induction charger 20, and make sure the receiving inductor 522 is within the induction distance, the rechargeable battery 50 is ready to be charged wirelessly. Also, multiple portable electronic devices 40, or multiple portable devices 40 and rechargeable batteries 50 removed from their devices can be charged using the same inductive charger 20 at the same time.

In another embodiment of the present invention, the inductive charge 20 is electrically connected with the vehicle outlet. The inductive charge 20 comprises a device holder 24. The device holder 24 comprises a receiving cavity 241 which receives the transmitting inductor 22, and a holding cavity 242 which holds the rechargeable battery 50, or the portable electronic device 70 having a rechargeable battery 50 installed. The holding cavity 242 holds the rechargeable battery 50, or the portable electronic device 70 having a rechargeable battery 50 installed in such a manner that the distance between the receiving inductor 522 of the rechargeable battery 50 and the transmitting inductor 22 is within the induction distance, so that inductive charging energy can be wirelessly transmitted form the inductive charger 20 to the energy storage module 51 of the rechargeable battery 50 to realize contact free charging.

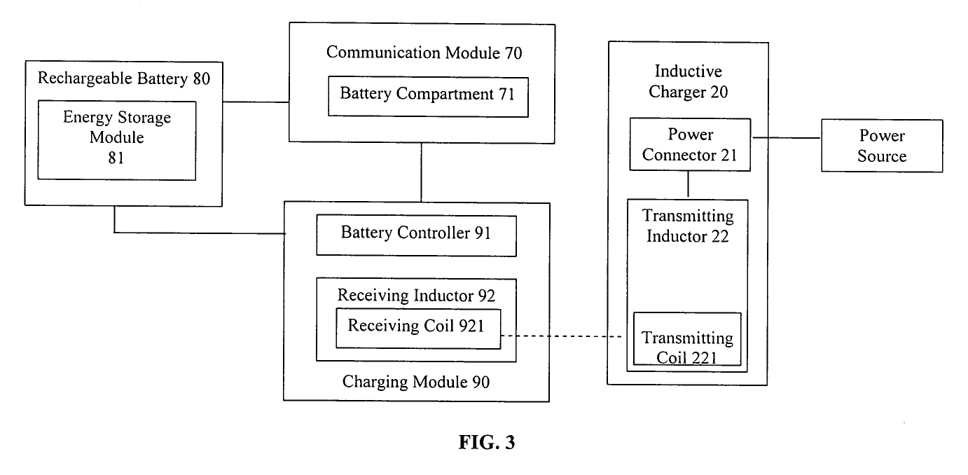

Referring to FIG. 3, the charging module of the present invention is built-in with the mobile communication device such that any rechargeable battery can be used for being charged in a wire-free manner when the rechargeable battery is plugged in the mobile communication device.

Accordingly, the mobile communication device comprises a communication module 70 which is functioned for wireless communication, for example, a mobile phone. This communication module 70 has a battery compartment 71. A rechargeable battery 80 is disposed in the battery compartment 71 of the communication module 70 and comprises an energy storage module 81 which is electrically coupling with the communication module 70. The energy storage module 81 can store electric energy by charging, and supply energy for the operation of the mobile communication device by discharging. In a preferred embodiment, the rechargeable battery is a regular rechargeable battery.

The mobile communication device also comprises a charging module 90, which further comprises a battery controller 91, a receiving inductor 92, and an inductive charger 93. The charging module 90 is built-in with the communication module 70. The battery controller 91 is electrically connected to the rechargeable battery 80 when the rechargeable battery 80 is disposed in the battery compartment 71. The battery controller 91 is also electrically coupling with the receiving inductor 92.

The receiving inductor 92 comprises a receiving coil 921 which receives magnetic flux and generates current by induction. This current is then rectified and passed by the battery controller 91 to the energy storage module 81 to realize charging. In a preferred embodiment, the receiving coil 921 is fabricated in thin metal film. The thin metal film has a relatively small dimension. It occupies minimal volume and can be integrated into a tight space within the communication module 70.

The inductive charger 93 transmits electric power into electromagnetic power therefore the receiving inductor 92 can receive. The inductive charger 93 comprises a power connector 931 adapted for electrically connecting with a power source, and a transmitting inductor 932 electrically coupling with the power connector 931. the transmitting inductor 932 comprises a transmitting coil 9321 for generating an electromagnetic induction, so the receiving inductor 92 is electrically inducted by the transmitting inductor 932 in a contact free manner for wirelessly transmitting an inductive charging power to the energy storage module 81 in such a manner that when the rechargeable battery 80 is located within an induction distance of the inductive charger 93, the energy storage module 81 of the rechargeable battery 80 is automatically charged.

In a preferred embodiment, the inductive charger 90 also comprises a charging base 933. The charging base 933 comprises a receiving cavity 9331 which receives the transmitting inductor 932, and a top platform 9332 which is positioned above the transmitting inductor 932. The distance between the top platform 9332 and the transmitting inductor 932 is within the induction distance. In this embodiment of the present invention, the communication module 70 can be positioned over the top platform 9332 of the inductive charger 93 with the receiving inductor 92 locating within the induction distance and can be induced to generate charging current. Also there is no need of physical contact and conductive connection between the communication module 70 and the inductive charger 93. For example, if simply place a mobile phone having the charging module 70 over the top platform 9332 of the inductive charger 93 electrically connected with a power, the charging of the deposited rechargeable battery 80 will begin automatically.

In this embodiment of the invention, multiple communication modules 70 can be placed over the top platform 9332, and can be charged using a same inductive charger 93 at the same time.

The rechargeable battery 50 can also be charged when it is installed within the portable electronic device 40. Place a portable electronic device 40 which has a rechargeable battery 50 of the rechargeable battery arrangement of the present invention over the top platform 222 of the induction charger 20, and make sure the receiving inductor 522 is within the induction distance, the rechargeable battery 50 is ready to be charged wirelessly. Also, multiple portable electronic devices 40, or multiple portable devices 40 and rechargeable batteries 50 removed from their devices can be charged using the same inductive charger 20 at the same time.

In another embodiment of the present invention, the inductive charge 93 is electrically connected with the vehicle outlet. The inductive charge 93 comprises a device holder 934 which can hold the communication module 70 to realize contact free charging.

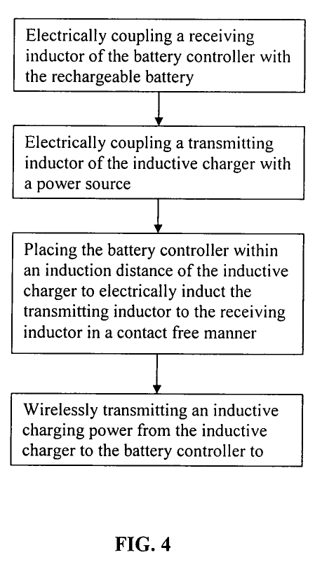

FIG. 4 illustrates a charging method for charging a replaceable battery by a recharging module which comprises a battery controller and an inductive charger comprising the steps of:

(a) electrically coupling a receiving inductor of the battery controller with the rechargeable battery;

(b) electrically coupling a transmitting inductor of the inductive charger with a power source;

(c) placing the battery controller within an induction distance of the inductive charger to electrically induct the transmitting inductor to the receiving inductor in a contact free manner; and

(d) wirelessly transmitting an inductive charging power from the inductive charger to the battery controller to electrically charge the rechargeable battery.

In step (a), the first circuit loop is built up by coupling the receiving inductor and the replaceable battery. So induction current generated by the receiving inductor can flow into the rechargeable battery. Accordingly, the battery controller is externally connected to the mobile communication device to electrically connect to the rechargeable battery. The battery controller can be built-in with the rechargeable battery. Likewise, the battery controller is built-in with the mobile communication device to electrically connect to the rechargeable battery.

In step (b), the second circuit loop is built up by coupling the transmitting inductor and the power source. So the electric power can be transformed into electromagnetic power, and magnetic flux is generated for induction.

In step (c), when the battery controller and the transmitting inductor are placed within the induction distance of the inductive charger, the receiving inductor is inducted by the magnetic flux generated by the transmitting inductor, and consequently generates an induction current which flows into the replaceable battery for charging. Also, multiple battery controllers can be placed within the induction distance of the inductive charger, so that more than one receiving inductors and be induced, and more than one rechargeable batteries can be charged at the same time.

In this manner, the electric energy is transmitted into the replaceable battery. During the process, the receiving inductor and the transmitting inductor are not conductively connected, and are also not need to be physically contacted. In this way charging is performed wirelessly.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A charging module for a portable electronic device having a rechargeable battery, comprising:
a battery controller comprising a battery connector adapted for electrically connecting to said rechargeable battery of said portable electronic device, and a receiving inductor electrically coupling with said battery connector; and
an inductive charger comprising a power connector adapted for electrically connecting with a power source, and a transmitting inductor electrically coupling with said power connector for generating an electromagnetic induction, wherein said receiving inductor is electrically inducted to said transmitting inductor in a contact free manner for wirelessly transmitting an inductive charging power to said rechargeable battery of said portable electronic device through said transmitting inductor in such a manner that when said rechargeable battery of said portable electronic device is located within an induction distance of said inductive charger, said rechargeable battery of said portable electronic device is automatically charged.

2. The charging module, as recited in claim 1, wherein said inductive charger comprises a charging base having a receiving cavity receiving said transmitting inductor and a top platform positioned above said receiving cavity within said induction distance for said receiving inductor resting on said top platform to electrically induct said receiving inductor to said transmitting inductor in a contact free manner so as to wirelessly transmit said inductive charging power to said rechargeable battery.

3. The charging module, as recited in claim 1, wherein said power connector comprises a wall plug for electrically connecting with a wall outlet as said power source with 100-240 AV output.

4. The charging module, as recited in claim 2, wherein said power connector comprises a wall plug for electrically connecting with a wall outlet as said power source with 100-240 AV output.

5. The charging module, as recited in claim 1, wherein said inductive charger comprises a device holder having a receiving cavity receiving said transmitting inductor and a holding cavity positioned nearby said transmitting inductor within said induction distance for said portable electronic device disposing at said holding cavity to electrically induct said receiving inductor to said transmitting inductor in a contact free manner so as to wirelessly transmit said inductive charging power to said rechargeable battery.

6. The charging module, as recited in claim 1, wherein said power connector comprises a DC power plug for electrically connecting with a vehicle electric outlet as said power source with 12DC output.

7. The charging module, as recited in claim 5, wherein said power connector comprises a DC power plug for electrically connecting with a vehicle electric outlet as said power source with 12DC output.

8. A rechargeable battery arrangement for a portable electronic device, comprising:
a rechargeable battery, which is adapted for electrically coupling with said portable electronic device, comprising an energy storage module and a battery controller, wherein said battery controller comprises a battery connector electrically connecting to said energy storage module and a receiving inductor electrically coupling with said battery connector; and
an inductive charger comprising a power connector adapted for electrically connecting with a power source, and a transmitting inductor electrically coupling with said power connector for generating an electromagnetic induction, wherein said receiving inductor is electrically inducted to said transmitting inductor in a contact free manner for wirelessly transmitting an inductive charging power to said energy storage module through said transmitting inductor in such a manner that when said rechargeable battery is located within an induction distance of said inductive charger, said energy storage module of said rechargeable battery is automatically charged.

9. The rechargeable battery arrangement, as recited in claim 8, wherein said rechargeable battery further comprises a frame receiving and said energy storage module and said battery controller, and two electrodes formed at said frame to electrically extended from said energy storage module.

10. The rechargeable battery arrangement, as recited in claim 9, wherein said inductive charger comprises a charging base having a receiving cavity receiving said transmitting inductor and a top platform positioned above said receiving cavity within said induction distance for said rechargeable battery resting on said top platform to electrically induct said receiving inductor to said transmitting inductor in a contact free manner so as to wirelessly transmit said inductive charging power to said rechargeable battery.

11. The rechargeable battery arrangement, as recited in claim 9, wherein said inductive charger comprises a device holder having a receiving cavity receiving said transmitting inductor and a holding cavity positioned nearby said transmitting inductor within said induction distance for said rechargeable battery disposing at said holding cavity to electrically induct said receiving inductor to said transmitting inductor in a contact free manner so as to wirelessly transmit said inductive charging power to said rechargeable battery.

12. A mobile communication device, comprising:
a communication module, having a battery compartment, for wirelessly transmitting a communication signal;
a rechargeable battery, which is disposed in said battery compartment of said communication module, comprising an energy storage module electrically coupling with said communication module; and
a charging module, comprising:
a battery controller, which is built-in with said communication module, comprising a battery connector electrically connecting to said rechargeable battery when said rechargeable battery is disposed in said battery compartment, and a receiving inductor electrically coupling with said battery connector; and
an inductive charger comprising a power connector adapted for electrically connecting with a power source, and a transmitting inductor electrically coupling with said power connector for generating an electromagnetic induction, wherein said receiving inductor is electrically inducted to said transmitting inductor in a contact free manner for wirelessly transmitting an inductive charging power to said energy storage module through said transmitting inductor in such a manner that when said rechargeable battery is located within an induction distance of said inductive charger, said energy storage module of said rechargeable battery is automatically charged.

13. The mobile communication device, as recited in claim 12, wherein, said inductive charger comprises a charging base having a receiving cavity receiving said transmitting inductor and a top platform positioned above said receiving cavity within said induction distance for said receiving inductor resting on said top platform to electrically induct said receiving inductor to said transmitting inductor in a contact free manner so as to wirelessly transmit said inductive charging power to said rechargeable battery.

14. The mobile communication device, as recited in claim 12, wherein said power connector comprises a wall plug for electrically connecting with a wall outlet as said power source with 100-240 AV output.

15. The mobile communication device, as recited in claim 13, wherein said power connector comprises a wall plug for electrically connecting with a wall outlet as said power source with 100-240 AV output.

16. The mobile communication device, as recited in claim 12, wherein said inductive charger comprises a device holder having a receiving cavity receiving said transmitting inductor and a holding cavity positioned nearby said transmitting inductor within said induction distance for said communication module disposing at said holding cavity to electrically induct said receiving inductor to said transmitting inductor in a contact free manner so as to wirelessly transmit said inductive charging power to said rechargeable battery.

18. The mobile communication device, as recited in claim 12, wherein said power connector comprises a DC power plug for electrically connecting with a vehicle electric outlet as said power source with 12DC output.

19. The mobile communication device, as recited in claim 16, wherein said power connector comprises a DC power plug for electrically connecting with a vehicle electric outlet as said power source with 12DC output.

20. A charging method for charging a replaceable battery of a mobile communication device by a recharging module which comprises a battery controller and an inductive charger, comprising the steps of:
(a) electrically coupling a receiving inductor of said battery controller with said rechargeable battery;
(b) electrically coupling a transmitting inductor of said inductive charger with a power source;
(c) placing said battery controller within an induction distance of said inductive charger to electrically induct said transmitting inductor to said receiving inductor in a contact free manner; and
(d) wirelessly transmitting an inductive charging power from said inductive charger to said battery controller to electrically charge said rechargeable battery.

21. The method as recited in claim 19 wherein, in step (a), said battery controller is externally connected to said mobile communication device to electrically connect to said rechargeable battery.

22. The method as recited in claim 19 wherein, in step (a), said battery controller is built-in with said rechargeable battery.

23. The method as recited in claim 19 wherein, in step (a), said battery controller is built-in with said mobile communication device to electrically connect to said rechargeable battery.
